(19) United States
(12) Patent Application Publication
(10) Pub. No.: US 2019/0220824 A1
(43) Pub. Date: Jul. 18, 2019

(54) MACHINE LEARNING SYSTEMS FOR MATCHING JOB CANDIDATE RESUMES WITH JOB REQUIREMENTS

(71) Applicant: Wei Liu, Redmond, WA (US)

(72) Inventor: Wei Liu, Redmond, WA (US)

(21) Appl. No.: 16/246,194

(22) Filed: Jan. 11, 2019

Related U.S. Application Data
(60) Provisional application No. 62/616,550, filed on Jan. 12, 2018.

(51) Int. Cl. G06Q 10/10; G06Q 10/06; G06N 20/00

(52) U.S. Cl. CPC G06Q 10/1053; G06N 20/00; G06Q 10/063112

(57) ABSTRACT

A machine learning system for matching job candidates' resumes to one or more job opening requirements based on a predictive system that includes machine learning from a large number of resume profile data sets and job opening requirements data sets. The machine learning system includes a resume data training engine that receives a plurality of resume profiles data having a plurality of time slices of job requirement data. The received data is used to determine a plurality of features and generate a predictive model. The system also includes a resume matching runtime engine that utilizes the predictive model to generate matching data regarding a plurality of resume records data relative to the one or more job descriptions using the predictive model.

### FIELD OF THE INVENTION

The present disclosure relates to automated systems for matching resumes from job applicants to job posting requirements based on machine learning techniques, and providing interviewing and hiring recommendations.

### BACKGROUND

### Description of the Related Art

Machine learning systems have been successfully developed and commercially deployed in numerous areas such as image processing, voice recognition, autonomous driving, gaming (such as Go), and medical diagnosis. Although software tools and automated systems have been used in the human resources (HR) field, machine learning system developed and deployed in this field have been limited.

Currently, it takes tremendous resources for employers to find suitable candidates to fill in different types of job openings. The traditional hiring procedures are typically performed as follows: employers receive job applicants' resumes, which are submitted online, through an agent, or mailed/emailed in; the resumes are filtered and a short list of candidates are selected for phone or on-site interviews; hiring decisions are reached after one or more rounds of interviews; finally the successful candidates are offered the job. It is not uncommon that hundreds, sometimes thousands, of resumes are submitted for one job opening.

There are many existing systems deployed to facilitate employers in filtering and sorting resumes. Almost all existing systems focus on extracting, transforming, and loading (ETL) resumes first, then retrieving/parsing resume data and using these data directly to find correlations between the resume data and the job posting requirements. In these systems, data records, such as schools, past employers, work experience, skills mentioned in the resumes are matched against the job requirements from employers. Those systems then score or rank the resumes based on these data matches. The use of these existing resume processing systems emphasizes keyword matches but overlooks much of important interrelated relevant data. For example, the job-related data for each individual applicant over time (e.g., how applicants advance in their careers, what employers and locations applicants have been choosing), and interrelationships between all these applicants' education and work history data (e.g., specific educational background such as major or certificate, and what kind of past employers are more relevant for a specific job opening). The current isolated, word-matching-based systems simply cannot provide heuristic insights or predictive analysis of each candidate's fitness and potentials for specific job positions. These traditional “word-matching” systems lack insights and ability to self-improve over time.

Recently, some systems and methods are designed with added personality tests, technical tests, or question assessments to add more filters for the candidate resumes. However, these additional assessments are used as more or less another layer of filters in existing systems. As a result, much of the resume review process still relies on HR-designed or HR-selected filtering/sorting criteria.

For example, an employer tries to evaluate a candidate with the right skill sets who just quit his previous job after one year of employment, and who also has a history of often quitting jobs within two years. Because the existing systems only consider isolated or “snapshot” information regarding applicant's qualifications on the resumes, this applicant would keep showing up on top of the short list because his skills match the job requirements. For an employer looking for a candidate who would stay in a position for a relatively long period, this candidate should not be ranked on top of the list and could result in resources wasted if this candidate were hired and then soon quit his job. On the other hand, the same candidate should possibly be placed on top of other resume search results, wherein the searches, possibly from start-ups, are looking for people with the right skill sets and are willing to take more risks in the job market in exchange for experience and higher potential rewards. The current isolated ways of applicant resume filtering/sorting are not adequate to cope with the increasing complexity of resume searching requirements. A more intelligent, efficient, self-learning, next-generation system that could learn from “past” (e.g. education, work experience, career path, company preference, location preference), predict “future” (e.g. job performance, position fit, company culture fit, location preference), and improve itself with time, is needed.

To address the inefficiencies of the current resume processing systems, there exists a need to process job applicant information, especially resume data, by exploring the deep connections inside career-related data, especially job applicants' education and career histories, to provide better recommendations and matches of applicants' resumes to employers based on machine learning techniques.

### BRIEF SUMMARY

The present disclosure is directed to a machine learning system for matching job candidates' resumes to one or more job opening requirements based on a predictive system including means of performing training using a large number of resume profile data sets and job opening requirements data sets based on machine learning techniques.

In one implementation, a machine learning system for matching a plurality of resumes is disclosed, the system may be summarized as including a resume data training engine, including a first set of one or more processors; at least one non-transitory processor-readable medium that stores at least one of processor executable instructions that, when executed by the first set of one or more processors: cause the first set of one or more processors to: receive a plurality of resume profile data corresponding to a plurality of job candidates, respectively, each of the resume profile data including a plurality of time slice data from a job candidate of the plurality of job candidates, wherein each of the plurality of time slice data includes resume data of the job candidate up to a time corresponding to the time slice, and job description of the job position of the candidate at the time, determine a plurality of features based on the plurality of resume profile data and the plurality of time slices data generate a predictive model that includes one or more functions or models by employing one or more machine learning algorithms to train from the plurality of features, each of the generated functions or models is associated with one or more of the plurality of features; and a resume matching runtime engine, including a second set of one or more processors; and at least another one non-transitory processor-readable medium that stores second processor executable instructions that, when executed by the second set of one or more processors, cause the second set of one or more processors to: receive the predictive model from the resume data training engine; receive one or more job descriptions receive a plurality of resume records data; extract one or more features from the one or more job descriptions; generate matching data regarding the plurality of resume records data relative to the one or more job descriptions using the predictive model based on the plurality of resume records data using the one or more extracted features, wherein the matching data includes matching score information for each of the plurality of resume records data, and present the matching data to a user.

In another implementation, the present disclosure provides that resume profile data may include personal information data, location data, education data, skills data, or one or more work experience data. The education data may include school attended, degree, GPA, major, or awards. Each of the work experience data may include employer, location, title, duty, or compensation.

The matching data of the plurality of resume data may further include annotations for one or more of the resume records data. The annotations information may include hiring recommendation information, reasoning information for the matching scores, or other related information. The matching data of the plurality of resume data may be transmitted to the resume data training engine for further training of the predictive model. The transmission of the matching data from the resume matching runtime engine to the resume data training engine may be transmitted after it is available. The transmission of the matching data from the resume matching runtime engine to the resume data training engine may be transmitted periodically. The job description data may include title, location, education, skills, experience, or compensation. Feedback data from one or more users of the machine learning system regarding previous resume matching results may be transmitted to the resume data training engine for further training of the predictive model.

A computer-implemented machine learning method for matching a plurality of resumes may be summarized as including receiving a first plurality of resume record data corresponding to a plurality of job candidates, respectively, each of the first resume record data including a plurality of time slice data from a respective job candidate of the plurality of job candidates, wherein each of the plurality of time slice data including resume data of the respective job candidate up to a time corresponding to the time slice, and a job description of a job position of the respective job candidate at the time; determining a plurality of features based on the first plurality of resume record data and the plurality of time slices data; employing machine learning to train and generate a predictive model from the first plurality of resume record data and the plurality of time slice data, the predictive model including one or more functions or models associated with one or more of the plurality of features; receiving one or more job descriptions; receiving a second plurality of resume records data for the one or more job descriptions; extracting one or more features from the one or more job descriptions; generating matching data for the second plurality of resume records data using the predictive model based on the second plurality of resume records data and the one or more extracted features, wherein the matching data includes matching score information for each of the second plurality of resume records data; and presenting the matching data to a user.

In a further implementation, the present provides that each of the first resume record data may include personal information data, location data, education data, skills data, or one or more work experience data. The education data may include school attended, degree, GPA, major, or awards. Each of the work experience data may include employer, location, title, duty, or compensation.

The matching data of the second plurality of resume record data may further include annotations for one or more of the second resume record data. The annotations information may include hiring recommendation information, reasoning information for the matching scores, or other related information. The matching data of the second plurality of resume records data may be used for further training the predictive model. The job description data may include title, location, education, skills, experience, or compensation. Feedback data regarding previous resume matching results may be used for further training of the predictive model.

A non-transitory computer-readable medium storing computer readable instructions that, when executed by one or more processors, perform a machine learning method may be summarized as including receiving a plurality of resume profile data corresponding to a plurality of job candidates, respectively, each of the resume profile data including a plurality of time slice data from a job candidate of the plurality of job candidates, wherein each of the plurality of time slice data includes resume data of the job candidate up to a time corresponding to the time slice, and a job description of a job position of the job candidate at the time; determining a plurality of features based on the plurality of resume profile data and the plurality of time slices data; employing machine learning to train and generate a predictive model from the plurality of resume profile data and the plurality of time slice data, the predictive model includes one or more functions or models associated with one or more of the plurality of features; receiving one or more job descriptions; receiving a plurality of resume records data; extracting one or more features from the one or more job descriptions; generating matching data for the plurality of resume records data using the predictive model based on the plurality of resume records data and the one or more extracted features, wherein the matching data includes matching score information for each of the plurality of resume records data; and presenting the matching data to a user.

The matching data of the plurality of resume records data may be used by a resume data training engine for further training of the predictive model. Feedback data regarding previous resume matching results may be used for further training of the predictive model.

### BRIEF DESCRIPTION OF THE DRAWINGS

Implementations are described herein with reference to the following drawings. However, it is understood that the implementations are not limited to the specific methods and apparatus depicted herein.

FIG. 1 illustrates a network environment according to an implementation of the present disclosure;

FIG. 2 illustrates a system diagram according to an implementation of the present disclosure;

FIG. 3 illustrates a flowchart of the training process according to an implementation of the present disclosure;

FIG. 4 illustrates a flowchart of the resume matching process according to an implementation of the present disclosure;

FIG. 5A illustrates a diagram showing the operation of the Resume Data Training Engine according to an implementation of the present disclosure;

FIG. 5B illustrates a diagram showing the operation of the Resume Data Training Engine using a neural network algorithm according to an implementation of the present disclosure;

FIG. 6 illustrates career path diagram according to an implementation of the present disclosure;

FIG. 7 illustrates time slices from a candidate job history data according to an implementation of the present disclosure; and

FIG. 8 illustrates training process utilizing time slices data and virtual job opening requirements data according to an implementation of the present disclosure.

### DETAILED DESCRIPTION

The following example implementations are merely illustrative and should not be considered limiting. All the components disclosed could be implemented exclusively in software, exclusively in hardware, or in any combinations of hardware and software using known techniques. Apart from what is disclosed herein, there are numerous possible means to implement the present disclosure. For sake of clarification, some details of implementing disclosed components with known technologies are not fully described.

Throughout this disclosure, processed resumes refer to resumes containing data that has been processed and is presented in a structured way to enable resume processing systems to perform further processing. “Raw” resumes are resumes that are presented in its original unstructured formats, text based, or image based. Each of the servers referred to in this disclosure typically comprise one or more processors, a memory device, an input interface, and an output interface. Each server may also comprise one or more databases, or is connected to one or more databases, internally or externally.

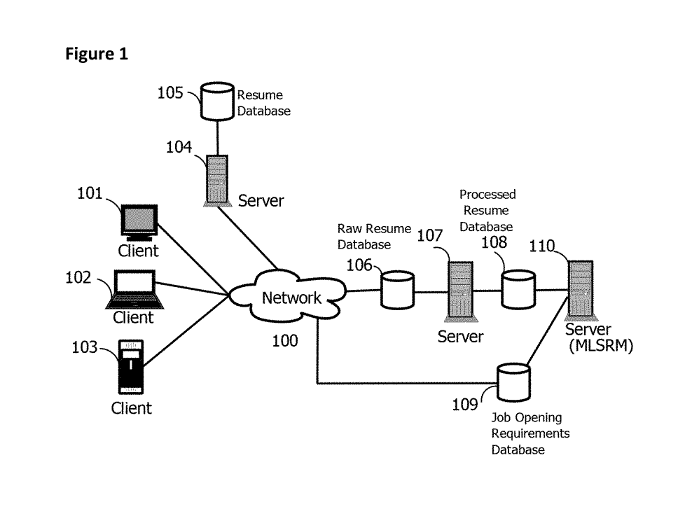

FIG. 1 shows a system diagram in a network environment according to an implementation of the present disclosure. Individual users may use a personal computer 101 or 102, a mobile device 103, or any other communications devices (not illustrated) to submit resumes to Raw Resume Database 106 via communications network 100. Alternatively, a server 104 that is connected, internally or externally, to a Resume Database 105, may also be connected to the communication network 100 to provide a plurality of resumes, “raw” or processed to the Raw Resume Database 106. Server 107 receives raw resumes from a Raw Resume Database 106 and processes the resumes. The processed resumes are stored in a Processed Resume Database 108. Note that processed resumes may be directly provided by an external database such as Resume Database 105 to the Processed Resume Database 108. Server 110 contains a Machine Learning System for Resume Matching (MLSRM) according to the present disclosure. The MLSRM receives processed resume data from database 108, and job opening requirements (JOR) data from a JOR database 109, as its input. Note that the JOR data may be obtained from data mining on the Internet, derived from external resume databases, provided by one or more employers, or some combination thereof. The results of resume processing of MLSRM are presented to a user of the server 110.

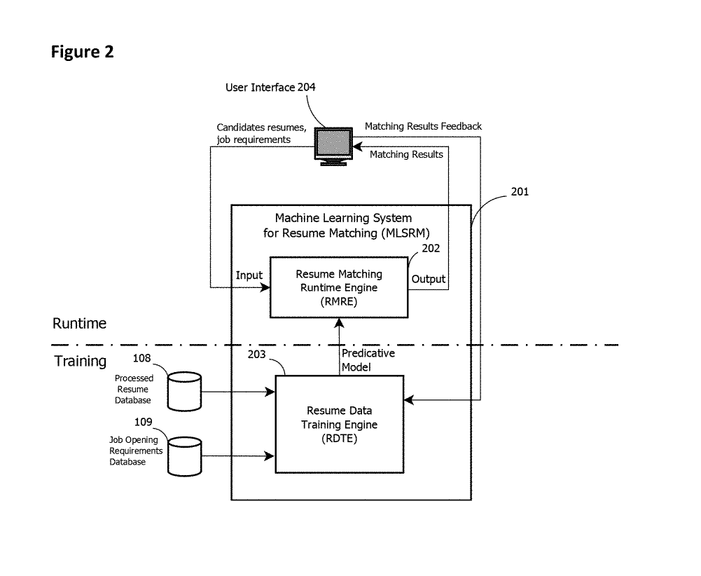

FIG. 2 illustrates a diagram of an implementation of the present disclosure. As mentioned in FIG. 1, the server 110 includes an MLSRM, which is illustrated as a Machine Learning System for Resume Matching (MLSRM) 201 in FIG. 2. The MLSRM 201 may be a software module of a server, a standalone software system, or a component implemented in hardware and software. Sometimes, an employer is already equipped with an existing resume filtering tool (ERFT) (not shown) to process raw resume data and perform basic filtering, such as from an Application Tracking System (ATS). In some implementations, where employers do not have an existing resume processing system, the functions of ERFT may also be incorporated into MLSRM and become a module inside MLSRM (not shown).

The MLSRM 201 comprises two components: a Resume Data Training Engine (RDTE) 203 and a Resume Matching Runtime Engine (RMRE) 202. The RDTE 203 is used for performing training using job-related data in the training stage. And the RMRE 202 is a component used for matching lists of resume records in an operational environment.

In one implementation, the RDTE 203 receives a list of a plurality of resume records from the Processed Resume Database 108. Optionally, the RDTE 203 may also receive a plurality of job opening requirements (JOR) data from a JOR Database 109, as inputs for training purposes. The list of resume records and JOR data may be obtained from internal or external resources, locally or remotely. The records and JOR data may be updated real-time or periodically. The list of resume records, and the JOR data (if obtained), are utilized, as described herein, to train a predictive model using machine learning techniques. After each round of training with any new or updated inputs, the RDTE 203 generates an updated predictive model as a result. The predictive model is passed to RMRE 202 for runtime operations.

RMRE 202 is a runtime engine that receives a list of a plurality of resume records and one or more sets of job opening requirements (JOR) data. The RMRE 202 processes these data sets using the predictive model provided by the RDTE 203, and generates matching information for the list of resume records. The resume records and JOR data sets may be obtained from internal or external resources, such as from a user interface 204, provided by a user (e.g., a recruiter, or an HR personnel from an employer, etc.). Each of the resume records may include information related to education data, previous employment data, publication data, location data, technical skills data, and any other related data. Each of the JOR data sets may include information such as job title, location, education requirements, skills requirements, work experience requirements, and any other data related to the job opening.

The results of resume matching processes are typically presented to a user through a user interface, such as 204. The resulted matching information, together with the inputted JOR data sets and resume records are also transmitted back to the RDTE 203 for further training, which improves the performance of the RDTE 203 over time. This feedback transmission may be real-time, i.e., right after the matching information is available, or may be processed periodically, such as on a daily or weekly basis.

Optionally, users of the system may provide feedback information regarding the machining results, such as which candidates are hired based on the matching information, the reasoning of that, and which candidates are rejected due to other concerns. This feedback information is also transmitted to RDTE 203 for further training.

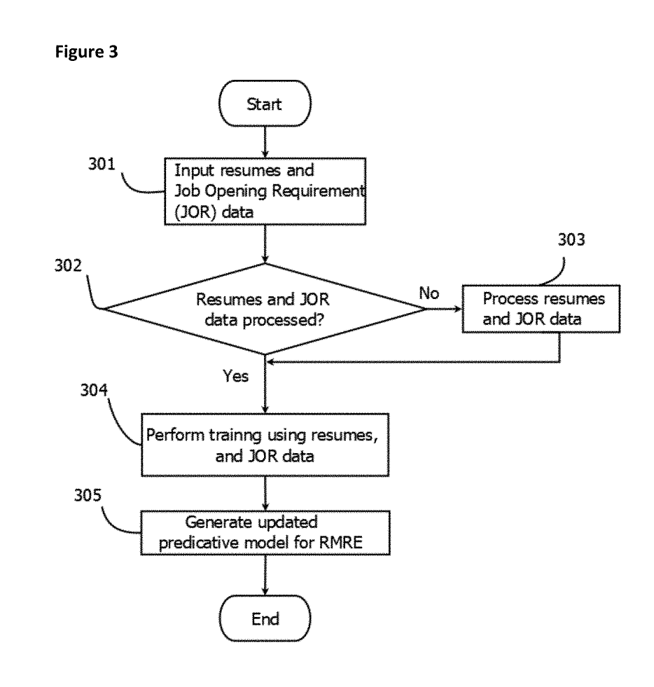

FIG. 3 shows an a flowchart of a process performed by the RDTE 203 of the present disclosure. In step 301, resume data and the optional JOR data is fed to the system. In step 302, the system checks if the resume and JOR data is processed, e.g., presented as structured data with parameters readily to be parsed by the RDTE 203. If the resume data is not processed, it is sent to a job data clean module (not shown) to be processed (step 303). In step 304, the system performs training using the processed resume data and JOR data. In step 305, a predictive model is generated as the result of training, which will be used by the RMRE 202.

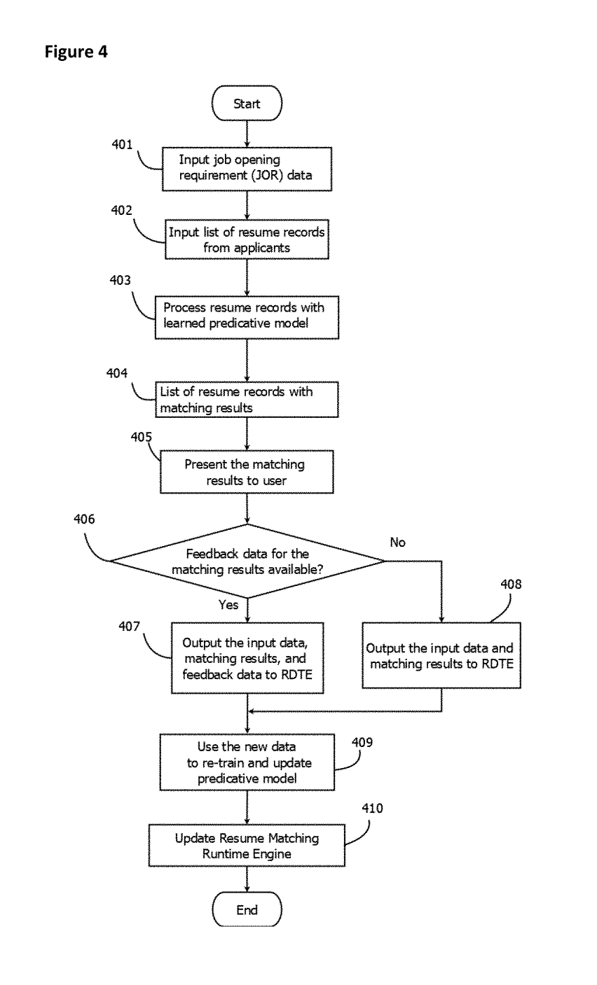

Referring to FIG. 4, when processing a request to rank a list of resume records, one or more job opening requirements (JOR) records are received at the RMRE 202 in step 401. In step 402, a list of resume records, which is to be matched to the JOR data, is provided to the RMRE 202. In step 403, the Resume Matching Runtime Engine 202 uses the predictive model received from the RDTE 203, which comprises matching algorithms that are resulted from the machine learning in the training stage, to process the resumes in accordance with the JOR records. In Step 404, the matching result data is generated, including matching information for the resumes, and automatically generated annotations or flags to identify information that is important. The matching result data is presented to the user in step 405. In step 406, the RMRE 202 checks if a user provides feedback data regarding the matching results. If the feedback data is available, the inputted resume/JOR records data, matching results data, and the feedback data is passed to the RDTE 203 for further training (step 407). If the feedback data is not available, only the inputted resume/JOR records data and matching results data are passed to RDTE 203 for further training (step 408). In step 409, the RDTE 203 uses the newly acquired data to perform further training and generate an updated predictive model. In step 410, the updated predictive model is passed to the RMRE 202. This resume matching process may be executed for several rounds until a decisive event happens (e.g., a hiring decision is made, or the job opening is closed).

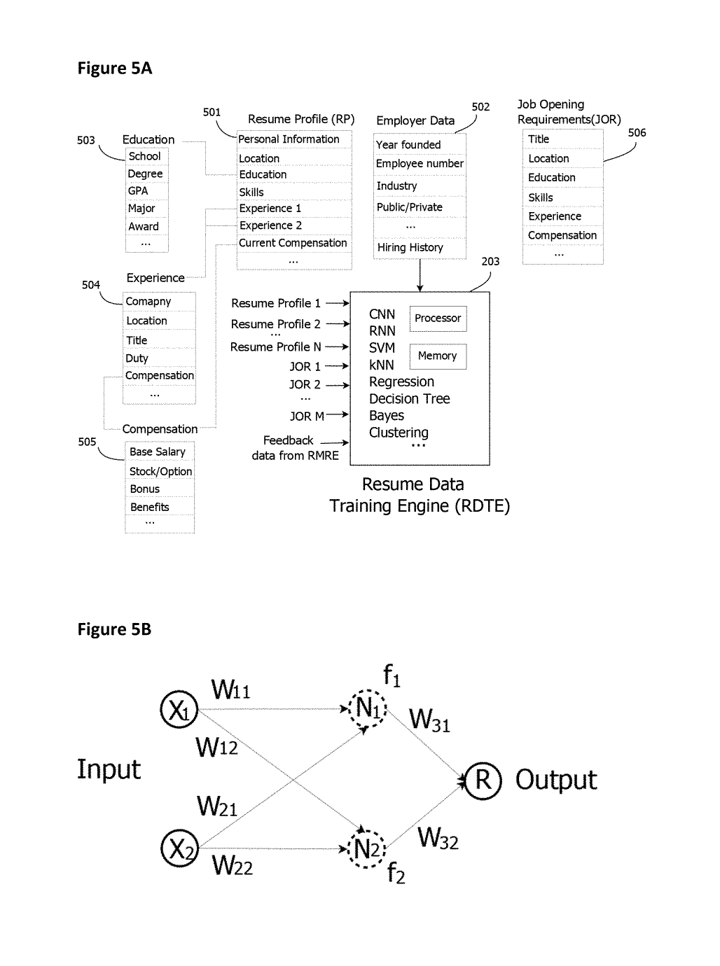

FIGS. 5A and 5B shows how the training engine RDTE 203 works. Beginning with FIG. 5A, the input data of the training engine includes a large number of processed resume profile data sets 501, a large number of processed job opening requirements (JOR) data sets 506 (optional), and optionally employer data 502. Each resume profile data 501 typically comprises data fields such as (1) personal information, which may comprise contact numbers, mailing address, email address, and social media accounts, etc.; (2) current location; (3) education 503, which may comprise schools attended, degrees or diploma earned, GPAs, major, awards, publication list, etc.; (4) a plurality of work experience 504, which may comprise employer name, title, location, responsibilities, compensation details, etc.; (5) current compensation details; (6) any other related data; or any combination thereof. Note that the “compensation” data 505 may include base salary, stocks/options, bonuses, benefits, etc.

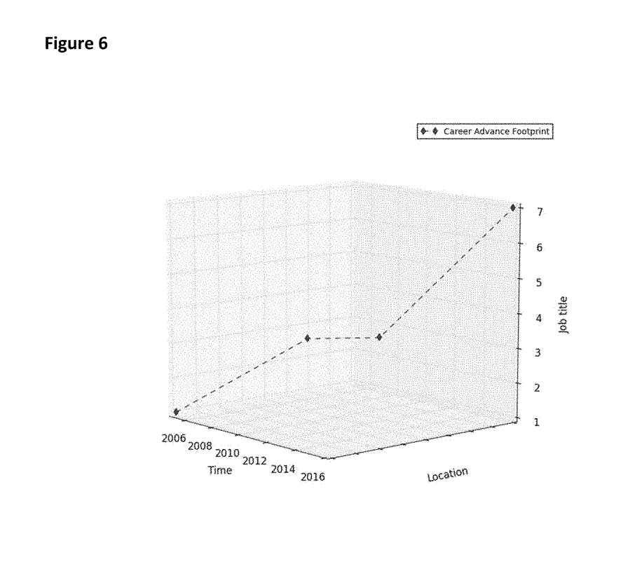

One aspect of training data used by the RDTE 203 is job candidates' past career history data. At any specific “snapshot of” candidates' combined career history, the status of each candidate is used for training purposes. These status data can be viewed as snapshots of candidates' “career footprints.” A single such “footprint” may comprise a job title, location, a time value, and/or other attributes, which may be viewed as a multidimensional vector. For a simplified version of the footprint that comprises a job title and a location at a certain time, the three-dimensional career advance footprints can be illustrated in a three-dimensional space. For example, FIG. 6 displays a job applicant's career path, who moved locations three times and received two promotions between 2005 and 2016. Aggregated past career footprint data is fact-based data that can be extracted from a large number of resume records. Utilizing these data as training data enables the RDTE 203 to achieve matching results with higher accuracy from the resume records data, alone or combined with other training data.

Returning to FIG. 5A, the RDTE 203 may also utilize feedback data from the RMRE 202 for training purposes. The feedback data may comprise data from resume matching activities, including inputted resume records data, JOR data, and matching results data. Optionally, the feedback data may also comprise feedback data from users of MLSRM regarding past matching results.

With all the training data, the RDTE 203 may utilize one or more machine learning algorithms to “learn” how to process and match resume profiles. The algorithm applied may be one or combination of a deep learning technique, a neural network algorithm such as Convolutional Neural Network (CNN) or Recurrent Neural Network (RNN), a Support Vector Machines (SVM) algorithm, a k-nearest neighbors algorithm (kNN), a regression algorithm such as linear regression algorithm, a decision tree algorithm, a Bayes algorithm such as naive Bayes algorithm, and other machine learning algorithms. The result of the training process may be a predictive model comprising one or more matching algorithms to the used by the RMRE 202.

An example training process is described here. Firstly, a number of features to be used in the training are selected, which may include job history data learned from the resume data for each applicant, education data, skills data, work experience data, location data, and any other related data. The feature selection may be implemented manually before the training stage, or maybe performed by an automatic feature selection algorithm, many of which are known in the art. Secondly, the features are used by the training with one or more above-mentioned machine learning algorithms. A simple example is to assign initial weights to different features and adjust these weights automatically and iteratively during the training stage with a large number of data sets based on machine learning algorithms such as CNN or RNN. The purpose of training is to produce a predictive model comprising a number of target functions. During training, all kinds of job related data connections and aspects are “learned” and incorporated into the predictive system. For example, from a large number of data sets the machine could learn that job applicants from around a specific location are not likely to move out of that specific location, which is indicated in their job history data; and job applicants working in a certain field tend to move out of specific locations within a certain period of time after they start jobs in that location (for example, a remote location in the oil and gas industry). Another example could be that for a certain company, a large percentage of the employees are graduated from a small number of universities. These two examples show location and education information in the resumes could provide more important insightful information than the “snapshot” data of these resumes. When features are processed and deep connections are learned, different weights maybe assigned to each feature or a combination of features, iteratively.

### Training Example 1

Regarding the above-mentioned examples, the weights could be assigned, including relocation willingness weight W₁ and school index weight W₂, which as defined below.

relocation willingness weight W₁=(W_{—high} if (location is A) and (job field is B)) or (W_{—low} (if location is C) and (job field is D)),

school index weight W₂=W₂₁ (if school is from group 1 for corporation X) or W₂₂ (if school is from group 2 for corporation X) . . . or W₂ₙ (if school is from group n for corporation X)

Many known machine learning algorithms, such as a regression algorithm, may be implemented to learn and know how to classify a location in a resume to W_{—high} or W_{—low}. For example, after training with resume data, the predictive model learns that last job location being in the Silicon Valley plus job field being Internet technologies would classify a resume's W₁ to W_{—high}. For example, a binary classification algorithm may be used, taking applicant's current location or distance to the job post, and job field as two input features, with past successful and or unsuccessful candidates from past hiring events as training data, to output a high score or low score.

Again, many known machine learning algorithms, such as multi-class classification algorithms, may be implemented to get W₂ from a resume. For example, after training with past resume data, the training module learns that graduates from Stanford University have a higher rate to be hired by company X, which would classify a resume's W₂ to W₂₁. In this case, the input of the machine learning algorithm is the school code and company identification, and output is a weight or score after the classification model.

These examples are merely for illustrative purposes, as there are numerous job-related features can be used in the system described herein to train the predictive model based on the input resume and requirements data. Moreover, while using certain machine learning techniques, for example, deep learning or clustering, unexpected data connections/features/patterns may be found among the different types of resume data. These connections/features/patterns are also incorporated in the resulting predictive system to produce more accurate results. At this stage, the predictive system would know how to classify different features of a resume and generate corresponding weights. As an example, a match score can be generated by adding all the weights up and multiplying the sum by an constant value, which can be output to a user indicating a relevancy of the corresponding resume.

### Training Example 2

Another example could be a career path success weight for particular job types. For example, a software engineer would have a higher level of success in a position of software architect if he or she advances his/her career from “software engineer” to “senior software engineer” in 5 years than another software engineer who takes more than 10 years to achieve the same senior position. These career advances are related to companies, titles of the jobs, and lengths of holding different job positions, the combination of which can be expressed in a function:

W₃=f(A, field, other relate data), wherein A is a set of entries, each entry being a dataset of (employer data, job title, years of service in the title, etc)

Another example to perform training is to utilize all features in a single machine learning algorithm, such as a neural network algorithm, to perform training and obtain a predictive model. For example, the features may include (1) years of work experience, (2) years stayed in current/last job position, (3) distance to the location of the job post, (4) number of skills matched with the job description, (5) frequency of job changes in the past 10 years, (6) education level, (7) or other resume features that are common to the training resume data.

To illustrate this, a fully connected neural network may be used to train the training data, which may include data from past hiring events. In this case, a weight would be assigned between any two of the selected features. How the weights are set would be the results of training. To reduce computational complexity when many features are selected, a CNN algorithm may be used to perform training with better efficiency.

In one non-limiting use case example, only two features are used to illustrate how the training may be implemented, as shown in FIG. 5B. The two features in use are “years stayed in current/last job position” (feature X₁), and “frequency of job promotions in the past 10 years” (feature X₂). Suppose there is one two-node hidden layer (node N₁ and node N₂), fully connected with the two input nodes, each of the node N₁ and node N₂ utilizes activation functions f₁(X₁, W₁₁, X₂, W₂₁) and f₂(X₁, W₁₂, X₂, W₂₂), respectively. f₁ and f₂ may be a sigmoid function or a multi-class classification function, or any suitable function known in the art. The output is a career path function R(f₁*W₃₁, f₂*W₃₂), which could be as simple as R( )=f₁*W₃₁+f₂ W₃₂, or any suitable functions. During training, data regarding “years stayed in current/last job position” and “frequency of job promotions in the past 10 years” of multiple successful candidates resumes in the past are used to train the model and adjust the weights. After many iterations of training, the predictive model would be accurate enough to be used in the runtime engine. For example, the model may learn that a software engineer would have a higher level of success in a position of software architect if he or she advances his/her career from “software engineer” to “senior software engineer” in 5 years than another software engineer who takes more than 10 years to achieve the same senior position. His/her resume would produce a very high career path success match score for a specific candidate based on their past resume data.

The above example only uses two features. In a real production environment, dozens of or even hundreds of features (automatically extracted or manually defined) can be used to generate the match score, using similar neutral network settings. In the cases with a large number of features, a CNN or RNN algorithm may be more efficient. Moreover, a large number of hidden layers may be employed to achieve more accurate results.

After the training stage, the Resume Match Runtime Engine 202 is updated with the learned predictive model and ready to be used for resume match.

As mentioned above, FIG. 6 illustrates an exemplary career path using only three parameters, time, location, and job title, which is presented in a 3-D space.

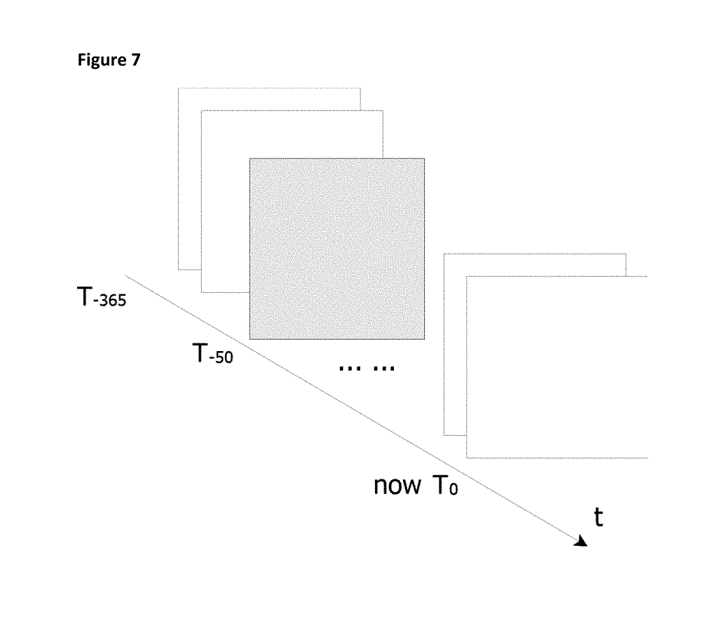

For a single candidate, his/her past job history data may be viewed as many “time slices,” which may be in the unit of day, month, or year, as illustrated by FIG. 7. Each of the time slices may be used for one round of training by the RDTE 203, the input data of the training is the candidate's resume up to that time slot, a “virtual job opening requirements,” which is the job description he/she was holding at that time, and a high matching score for the “match.” For the job the candidate was holding at the time, it is presumed that he/she succeeded in the job application process, which indicates a good match. For example, at T₋₅₀ which means 50 days before, John Doe was a software engineer in company A, and the job description is a set of information JD. Suppose the highest score for resume match is 100, we presume John Doe was a perfect match or near perfect match for the job he was holding. Therefore, the system uses John Doe's resume data at T₋₅₀, job description JD, and a high matching score (for example, a number between 80-100, selected by the system) for one iteration of training, presuming that with John Doe's resume data at T₋₅₀ being a near perfect match for virtual job opening requirement JD. With many iterations, each of which utilizes data corresponding to a single time slice, the training module would be able to achieve a learned predictive model.

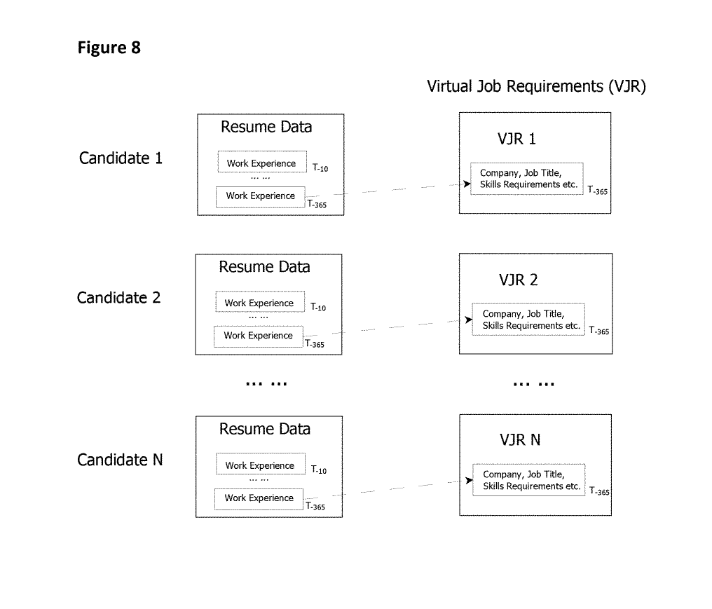

For a plurality of candidates, job data from each of them are used in training with the “time slicing” and “virtual job opening requirements” method, as illustrated in FIG. 8. Moreover, at a specified time slot, for example at T₋₅₀, the training module receives multiple resume data sets and multiple matching virtual job opening requirement data sets. The connections among these datasets are also used for training purposes. For example, at a certain time slot, a plurality of candidates might hold similar job titles with similar job descriptions. Over a period of time (a certain number of time slices later), these candidates may have different career paths: some progressed to more important job positions; some stayed in the same job position; and some changed job fields completely. This information may be used by the training module to build a more efficient and accurate predictive model.

These examples are merely for illustrative purposes, as there are numerous job-related features can be used in the system described herein to train a predictive model. Moreover, while using different machine learning techniques, for example, deep learning, clustering, etc, unexpected data connections/features may be found among the resume data. These connections/features are also incorporated in the resulting predictive system to produce more accurate results.

After the training stage, the Resume Matching Runtime Engine 202 is updated with the learned predictive model and ready to be used for resume matching.

The Resume Matching Runtime Engine (RMRE) 202 is a real-time system for matching resumes. It comprises a processor, memory, and an interface to receive inputs and an output interface, among other known computing components (not described herein for brevity). The memory may store, among other things, computer instructions that, when executed by the processor, cause the RMRE to perform actions described herein. Similarly, the RDTE 203 comprises a processor, memory, and an interface to receive inputs and an output interface, among other known computing components (not described herein for brevity). The memory may store, among other things, computer instructions that, when executed by the processor, cause the RDTE to perform actions described herein.

Before performing the resume matching tasks, the RMRE 202 is updated by the RDTE 203 with a predictive model comprising a plurality of functions based on one or more machine learning algorithms. Each of these functions may represent one or more features, as described in previous sections. These functions, in combination, produce a matching score and generate annotations/flags for the matching scores. There are numerous means to utilize these functions to generate a score. In an implementation, each of the functions would produce a weight for the one or more features it represents. How these weights may be generated has been described in previous sections.

During a resume matching operation, the input interface receives one or more sets of job opening requirements (JOR) for one or more job openings and a plurality of resume records data. Note that the resume records data may be submitted by the job applicants or collected via internal/external resources. Depending on the features contained in the JOR data sets, one or more functions in the predictive model are activated and start to process the feature data. The combination of the weights generated by the activated functions produces a final score for each resume record. In addition to the score, the functions may also generate annotations/flags for one or more of the resume records for the user to review. In various implementations, the annotations may include, hiring recommendation information, reasoning information for the matching scores, other related information, or some combination thereof. For example, annotations may be reasoning why a particular resume is placed at near the bottom of the list. In this case, the reasoning could be “5 jobs during the past 20 years in NYC, not likely to relocate to California,” or “10 years on the position of software developer, not likely to succeed as a software architect.” An example flag data could be “resume fits the current employer but not the current position. Possible candidate for future hiring,” or “Applied for positions in this employer for more than 10 times in the past.”

After the matching is completed, the Resume Matching Runtime Engine 202 presents a user a list of resume records with matching scores, together with optional annotations/flags for each of the resume entry. The matching results data, together with the inputted resume records and JOR data, are transmitted to the RDTE 203 for future training to improve the predictive system, as described in previous sections.

Although certain implementations of the present disclosure have been disclosed herein, they are provided merely for the purposes of explanations and illustrations and are in no way to be constructed as limiting. Various modifications and other implementations are intended to be included within the scope of this disclosure. All terms used in this disclosure are used in a generic and descriptive sense only and not for purposes of limitation. It is intended that the present disclosure not be limited to the implementations disclosed herein, but that the disclosure will include all implementations within the scope of the appended claims.

1. A machine learning system for matching a plurality of resumes, comprising:
a resume data training engine, comprising:
a first set of one or more processors;
at least one non-transitory processor-readable medium that stores at least one of processor executable instructions that, when executed by the first set of one or more processors, cause the first set of one or more processors to:
receive a plurality of resume profile data corresponding to a plurality of job candidates, respectively, each of the resume profile data comprising a plurality of time slice data from a job candidate of the plurality of job candidates, wherein each of the plurality of time slice data comprises resume data of the job candidate up to a time corresponding to the time slice, and job description of a job position of the candidate at the time;
determine a plurality of features based on the plurality of resume profile data and the plurality of time slices data; and
generate a predictive model that comprises one or more functions or models by employing one or more machine learning algorithms to train from the plurality of features, each of the generated functions or models is associated with one or more of the plurality of features; and
a resume matching runtime engine, comprising:
a second set of one or more processors; and
at least another one nontransitory processor-readable medium that stores second processor executable instructions that, when executed by the second set of one or more processors, cause the second set of one or more processors to:
receive the predictive model from the resume data training engine;
receive one or more job descriptions;
receive a plurality of resume records data;
extract one or more features from the one or more job descriptions;
generate matching data regarding the plurality of resume records data relative to the one or more job descriptions using the predictive model based on the plurality of resume records data using the one or more extracted features, wherein the matching data comprises matching score information for each of the plurality of resume records data; and
present the matching data to a user.

2. The machine learning system of claim 1, wherein each of the resume profile data comprises personal information data, location data, education data, skills data, or one or more work experience data.

3. The machine learning system of claim 2, wherein the education data comprises school attended, degree, GPA, major, or awards.

4. The machine learning system of claim 2, wherein each of the work experience data comprises employer, location, title, duty, or compensation.

5. The machine learning system of claim 1, wherein the matching data of the plurality of resume data further comprises annotations for one or more of the resume records data.

6. The machine learning system of claim 5, wherein the annotations information comprises hiring recommendation information, reasoning information for the matching scores, or other related information.

7. The machine learning system of claim 1, wherein the matching data of the plurality of resume data is transmitted to the resume data training engine for further training of the predictive model.

8. The machine learning system of claim 7, wherein the transmission of the matching data from the resume matching runtime engine to the resume data training engine is transmitted after it is available.

9. The machine learning system of claim 7, wherein the transmission of the matching data from the resume matching runtime engine to the resume data training engine is transmitted periodically.

10. The machine learning system of claim 1, wherein the job description data comprises title, location, education, skills, experience, or compensation.

11. The machine learning system of claim 1, wherein feedback data from one or more users of the machine learning system regarding previous resume matching results is transmitted to the resume data training engine for further training of the predictive model.

12. A computer-implemented machine learning method for matching a plurality of resumes, comprising:
receiving a first plurality of resume record data corresponding to a plurality of job candidates, respectively, each of the first resume record data comprising a plurality of time slice data from a respective job candidate of the plurality of job candidates, wherein each of the plurality of time slice data comprises resume data of the respective job candidate up to a time corresponding to the time slice, and a job description of a job position of the respective job candidate at the time;
determining a plurality of features based on the first plurality of resume record data and the plurality of time slices data;
employing machine learning to train and generate a predictive model from the first plurality of resume record data and the plurality of time slice data, the predictive model comprising one or more functions or models associated with one or more of the plurality of features;
receiving one or more job descriptions;
receiving a second plurality of resume records data for the one or more job descriptions;
extracting one or more features from the one or more job descriptions;
generating matching data for the second plurality of resume records data using the predictive model based on the second plurality of resume records data and the one or more extracted features, wherein the matching data comprises matching score information for each of the second plurality of resume records data; and
presenting the matching data to a user.

13. The computer-implemented machine learning method of claim 12, wherein each of the first resume record data comprises personal information data, location data, education data, skills data, or one or more work experience data.

14. The computer-implemented machine learning method of claim 13, wherein the education data comprises school attended, degree, GPA, major, or awards.

15. The computer-implemented machine learning method of claim 13, wherein each of the work experience data comprising employer, location, title, duty, or compensation.

16. The computer-implemented machine learning method of claim 12, wherein the matching data of the second plurality of resume record data further comprises annotations for one or more of the second resume record data.

17. The computer-implemented machine learning method of claim 16, wherein the annotations information comprises hiring recommendation information, reasoning information for the matching scores, or other related information.

18. The computer-implemented machine learning method of claim 12, wherein the matching data of the second plurality of resume records data is used for further training the predictive model.

19. The computer-implemented machine learning method of claim 12, wherein the job description data comprises title, location, education, skills, experience, or compensation.

20. The computer-implemented machine learning method of claim 12, wherein feedback data regarding previous resume matching results is used for further training of the predictive model.

21. A non-transitory computer-readable medium storing computer readable instructions that, when executed by one or more processors, perform a machine learning method comprising:
receiving a plurality of resume profile data corresponding to a plurality of job candidates, respectively, each of the resume profile data comprising a plurality of time slice data from a job candidate of the plurality of job candidates, wherein each of the plurality of time slice data comprises resume data of the job candidate up to a time corresponding to the time slice, and a job description of a job position of the job candidate at the time;
determining a plurality of features based on the plurality of resume profile data and the plurality of time slices data;
employing machine learning to train and generate a predictive model from the plurality of resume profile data and the plurality of time slice data, the predictive model comprises one or more functions or models associated with one or more of the plurality of features;
receiving one or more job descriptions;
receiving a plurality of resume records data;
extracting one or more features from the one or more job descriptions;
generating matching data for the plurality of resume records data using the predictive model based on the plurality of resume records data and the one or more extracted features, wherein the matching data comprises matching score information for each of the plurality of resume records data; and
presenting the matching data to a user.

22. The non-transitory computer-readable medium of claim 21, wherein the matching data of the plurality of resume records data are used by a resume data training engine for further training of the predictive model.

23. The non-transitory computer-readable medium of claim 21, wherein feedback data regarding previous resume matching results is used for further training of the predictive model.
